(19) United States
(12) Patent Application Publication
(10) Pub. No.: US 2022/0045334 A1
(43) Pub. Date: Feb. 10, 2022

(54) RESIN CURRENT COLLECTOR

(71) Applicants: GUNZE LIMITED, Ayabe-shi, Kyoto (JP); APB Corporation, Tokyo (JP)

(72) Inventors: Takehiro ISO, Moriyama-shi, Shiga (JP); Kazuaki ONISHI, Moriyama-shi, Shiga (JP); Hiroyuki NONAKA, Moriyama-shi, Shiga (JP); Yasuji MARUYAMA,, Moriyama-shi, Shiga (JP); Ryosuke KUSANO, Kyoto-shi, Kyoto (JP); Sonomi FUKUYAMA, Kyoto-shi, Kyoto (JP); Shun KUDOH, Kyoto-shi, Kyoto (JP); Yasuhiro TSUDO, Kyoto-shi, Kyoto (JP); Hideaki HORIE, Tokyo (JP)

(21) Appl. No.: 17/417,066

(22) PCT Filed: Sep. 3, 2020
(86) PCT No.: PCT/JP2020/033349

§ 371 Date: Jun. 21, 2021

(30) Foreign Application Priority Data
Nov. 29, 2019 (JP) 2019-216224

(51) Int. Cl. H01M 4/66; H01M 4/62

(52) U.S. Cl. CPC H01M 4/668; H01M 4/625

(57) ABSTRACT

A resin current collector is a current collector for a positive electrode of a lithium ion battery. This resin current collector includes a polyolefin resin and a conductive carbon filler. With this resin current collector, a value obtained by dividing the yield point strength in the TD (Traverse Direction) by the yield point strength in the MD (Machine Direction) is at least 0.75 and at most 1.10, and the ten-point average roughness Rz in the TD is less than 4 μm.

### TECHNICAL FIELD

The present invention relates to a resin current collector, and particularly relates to a resin current collector for a positive electrode of a lithium ion battery.

### BACKGROUND ART

JP 2019-75300A (Patent Literature 1) discloses a current collector made of resin (resin current collector). The current collector is a current collector for a lithium ion battery, and includes a polyolefin resin and a conductive carbon filler. In the current collector, the total surface area of the conductive carbon filler included in 1 g of the current collector is 7.0 to 10.5 m², which is small. This makes it difficult for a side reaction to occur on the surface of the conductive carbon filler, and thus the decomposition current that accompanies a decomposition reaction is smaller. As a result, with this current collector, it is possible to improve cycle characteristics (see Patent Literature 1).

### CITATION LIST

### Patent Literature

Patent Literature 1: JP 2019-75300A

### SUMMARY OF INVENTION

### Technical Problem

The current collector made of resin, which is disclosed in Patent Literature 1 above, accidentally tears in a manufacturing step in some cases.

The present invention was made in order to resolve these problems, and an object thereof is to provide a resin current collector with improved tear strength.

### Solution to Problem

A resin current collector according to the present invention is a resin current collector for a positive electrode of a lithium ion battery. This resin current collector includes a polyolefin resin and a conductive carbon filler. With this resin current collector, a value obtained by dividing the yield point strength in the TD (Traverse Direction) by the yield point strength in the MD (Machine Direction) is at least 0.75 and at most 1.10, and the ten-point average roughness Rz in the TD is less than 4 μm.

In the above-described resin current collector, the penetration resistance may also be at most 30 Ω·cm².

In the above-described resin current collector, the tear strength in the MD may also be at least 60 kN/m.

In the above-described resin current collector, the conductive carbon filler is carbon black, a thickness is at least 20 μm and at most 100 μm, the ten-point average roughness Rz in the TD is at least 0.5 μm and at most 3.7 μm, the yield point strength in the TD is at least 25 MPa, the yield point strength in the MD is at least 29 MPa, a value obtained by dividing the yield point strength in the TD by the yield point strength in the MD is at least 0.90 and at most 1.05, and the tear strength in the MD is at least 70 kN/m.

In the above-described resin current collector, the ten-point average roughness Rz in the TD is at least 0.7 μm and at most 2.5 μm, and the yield point strength in the TD is at least 29 MPa.

### Advantageous Effects of Invention

According to the present invention, it is possible to provide a resin current collector with an improved tear strength.

### BRIEF DESCRIPTION OF DRAWINGS

FIG. 1 is a diagram showing a shape of a test piece to be used to measure tear strength.

FIG. 2 is a diagram showing a T-die for manufacturing a current collector.

### DESCRIPTION OF EMBODIMENTS

Hereinafter, an embodiment of the present invention will be described in detail with reference to the drawings. Note that identical or corresponding portions in the drawings are denoted by identical reference numerals and description thereof will not be repeated.

### 1. CONFIGURATION OF CURRENT COLLECTOR

A current collector 100 according to the present embodiment is a so-called resin current collector, and for example, is used as a current collector for a positive electrode of a lithium ion battery. The current collector 100 is constituted by, for example, a single layer, and includes a polyolefin resin, a conductive carbon filler, and a dispersant for a conductive material.

Preferable examples of the polyolefin resin include polyolefin [polyethylene (PE), polypropylene (PP), polymethylpentene (PMP), polycycloolefin (PCO), etc.]. PE, PP, and PMP are examples of more preferable polyolefin resins.

As PE, for example, “NOVATEC LL UE320” and “NOVATEC LL UJ960” manufactured by Japan Polyethylene Corporation is commercially available.

As PP, for example, “Sun Allomer PM854X”, “Sun Allomer PC684S”, “Sun Allomer PL500A”, “Sun Allomer PC630S”, “Sun Allomer PC630A”, and “Sun Allomer PB522M” manufactured by Sun Allomer Ltd., “Prime Polymer J-2000GP” manufactured by Prime Polymer Co., Ltd., and “WINTEC WFX4T” manufactured by Nippon Polypropylene Corporation are commercially available.

As PMP, for example, “TPX” manufactured by Mitsui Chemicals, Inc. can be acquired on the market.

Examples of the conductive carbon filler include graphite, carbon black (acetylene black, Ketjen black, furnace black, channel black, thermal lamp black, etc.), and mixtures thereof. Note that the conductive carbon filler is not necessarily limited to these.

Examples of the dispersant for the conductive material include modified polyolefin and surfactants.

A current collector made of resin such as the current collector 100 is manufactured by, for example, cutting a current collector film manufactured through extrusion molding. With this kind of current collector film, anisotropy in the physical characteristics can occur in the MD (Machine Direction) and the TD (Traverse Direction). If the anisotropy in the physical characteristics in the MD and the TD is large, the current collector film will be easier to tear. In particular, the current collector film is often easier to tear in the MD. If the current collector film is easy to tear, the current collector film is accidentally torn in the manufacturing step of the current collector in some cases.

The inventors of the present invention have found that the tear strength of the current collector is not sufficiently improved by merely suppressing the anisotropy of the physical characteristics in the MD and the TD. In addition, the inventors of the present invention found that the tear strength of the current collector is sufficiently improved by suppressing the surface roughness in the TD. Due to the anisotropy of the physical characteristics in the MD and TD being suppressed and the surface roughness in the TD being suppressed, the tear strength is improved compared to the conventional technique in the current collector 100 according to the present embodiment. Hereinafter, various parameters of the current collector 100 will be described in detail.

### 2. VARIOUS PARAMETERS

2-1. Thickness

The thickness of the current collector 100 is preferably at least 20 μm and at most 100 μm. If the thickness is at most 100 μm, it can be said that the thickness of the current collector 100 is sufficiently low. On the other hand, if the thickness is at least 20 μm, the strength of the current collector 100 is sufficiently ensured.

2-2. Penetration Resistance

The electrical resistance value (penetration resistance value) in the thickness direction of the current collector 100 is preferably at most 30 Ω·cm². That is, due to including a sufficient amount of the conductive carbon filler, the current collector 100 has a penetration resistance value that is low enough that it functions as a current collector for a positive electrode of a lithium ion battery. The penetration resistance value is measured using, for example, the following method.

A 7 cm×7 cm sample is cut and taken out of the current collector 100, and the resistance value in the thickness direction (penetration direction) of the current collector 100 is measured using an electrical resistance measurement device [IMC-0240 type, manufactured by Imoto Machinery Co., Ltd.] and a resistance meter [RM3548, manufactured by HIOKI]. The resistance value of the current collector 100 is measured in a state in which a load of 2.16 kg has been placed on the electrical resistance measurement device, and the value 60 seconds after the load is placed is taken as the resistance value of the current collector 100. As shown in the following equation, a value obtained by multiplying the surface area (3.14 cm²) of the contact surface of a jig at the time of measuring the resistance is taken as the penetration resistance value (Ω·cm²). Penetration resistance value (Ω·cm²)=resistance value (A)×3.14 cm²

2-3. Yield Point Strength in MD

In the current collector 100, the yield point strength in the MD is preferably at least 29 MPa, and more preferably at least 32 MPa. The measurement of the yield point strength in the MD is performed using, for example, a method conforming to JIS-K-6732.

Regarding the dimensions of the sample used in the measurement of the yield point strength, the width is 10 mm, and the length is at least 110 mm (the length of a reference line in the sample is 40 mm±0-2). The thickness of the sample is measured at five points that are equidistant from each other in the length direction, and the average thickness is calculated based on the measured thicknesses at the five points. The specific measurement is performed using an autograph (Shimadzu precision universal tester AUTOGRAPH AG-X 500N). The tension speed at this time is 200 mm/min, the chart speed is 200 mm/min, and the grip interval is 40 mm. The maximum strength (yield point strength) is calculated based on an output graph.

2-4. Yield Point Strength in TD

In the current collector 100, the yield point strength in the TD is preferably at least 25 MPa, and more preferably at least 29 MPa. The measurement of the yield point strength in the TD is performed using, for example, a method conforming to JIS-K-6732. The dimensions and the like of the samples used during measurement and the specific measurement method are the same as in the above-described measurement method for the yield point strength in the MD.

2-5. Ratio of Yield Point Strengths

In the current collector 100, the value obtained by dividing the yield point strength in the TD by the yield point strength in the MD is at least 0.75 and at most 1.10, and preferably at least 0.90 and at most 1.05. That is, in the current collector 100, the difference between the yield point strengths in the TD and the MD is suppressed. In other words, in the current collector 100, the anisotropy in the physical characteristics in the TD and the MD is suppressed.

2-6. Ten-Point Average Roughness Rz in TD

In the current collector 100, the ten-point average roughness Rz in the TD is less than 4 μm, preferably at least 0.5 μm and at most 3.7 μm, and more preferably at least 0.7 μm and at most 2.5 μm. That is, in the current collector 100, the surface roughness in the TD is suppressed. Note that the ten-point average roughness Rz conforms to the conditions of JIS B601-1982. In order to suppress the ten-point average roughness Rz in the TD, for example, it is effective to reduce the relative surface area of the conductive carbon filler, employ a conductive carbon filler with a small aspect ratio, and narrow the particle size distribution of the conductive carbon filler.

2-7. Tear Strength in MD

In the current collector 100, the tear strength in the MD is at least 60 kN/m, and preferably at least 70 kN/m. That is, in the current collector 100, a high tear strength is realized in the MD. The measurement of the tear strength is performed using, for example, a method conforming to JIS-K-6732.

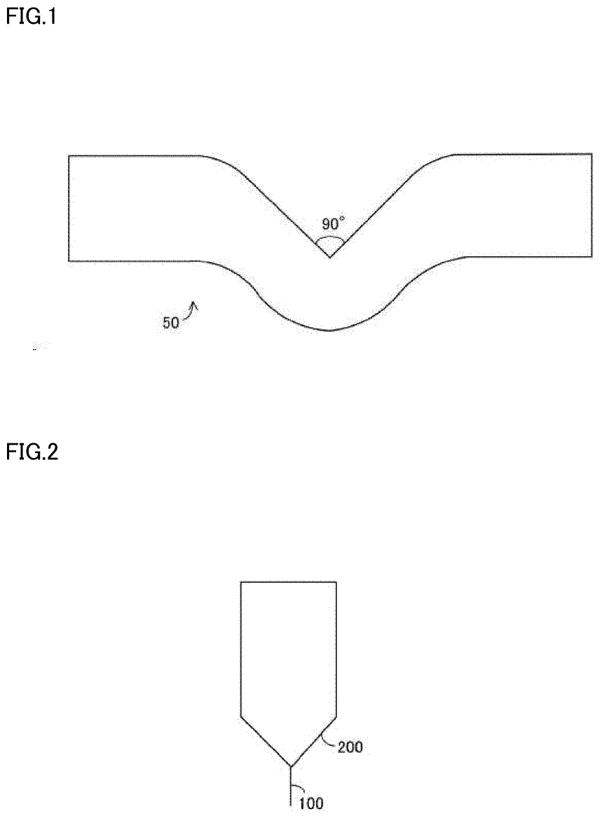

FIG. 1 is a diagram showing the shape of a test piece 50 that is used to measure the tear strength. In the measurement of the tear strength, a right-angle tear strength is measured. Specifically, a test piece cut out as shown in FIG. 1 is accurately attached to the tension tester with the axial direction of the test piece and the gripping tool direction of the tester matched. An autograph (Shimadzu precision universal tester AUTOGRAPH AG-X 500N) is used as the measurement device. The test speed is 200 mm/min and the strength during cutting of the test piece is measured.

### 3. MANUFACTURING METHOD

FIG. 2 is a diagram showing a T die 200 for manufacturing the current collector 100. As shown in FIG. 2, the current collector 100 is manufactured using, for example, the T die 200. Hereinafter, the manufacturing method of the current collector 100 will be described in detail.

First, a material for a resin current collector is obtained by mixing polyolefin resin, conductive carbon filler, and a dispersant for a conductive material. By introducing the obtained material for the resin current collector to the T die 200 and performing extrusion molding, a current collector film serving as the basis for the current collector 100 is manufactured. The current collector 100 is manufactured by cutting the current collector film.

The various conditions in the manufacture of the current collector 100 using the T die 200 are set such that the various parameters in the current collector 100 fall within the above-described ranges.

For example, it is possible to suppress the anisotropy in the MD and the TD of the current collector 100 by suppressing the discharge speed of the resin current collector material in the T die 200, setting the temperature in the T die 200 to be high, making the lip opening degree in the T die 200 small, or making the stretching ratio in the MD small.

Also, the ten-point average roughness Rz in the TD of the current collector 100 can be suppressed by, for example, setting the temperature in the T die 200 to be high, making the surface roughness of the lip in the T die 200 small, making the surface roughness of the roller used when collecting the current collector film small, or implementing a belt press for sandwiching with belts having small surface roughnesses on the current collector film.

### 4. CHARACTERISTICS

As described above, the inventors of the present invention found that the tear strength of the current collector 100 is improved due to the anisotropy in the physical characteristics in the MD and TD being suppressed and the surface roughness in the TD being suppressed. In the current collector 100 according to the present embodiment, the value obtained by dividing the yield point strength in the TD by the yield point strength in the MD is at least 0.75 and at most 1.10, and the ten-point average roughness Rz in the TD is less than 4 μm. That is, in the current collector 100, the anisotropy of the physical characteristics in the MD and TD is suppressed, and the surface roughness in the TD is suppressed. Accordingly, with the current collector 100, it is possible to improve the tear strength of the current collector.

### 5. MODIFIED EXAMPLES

Although an embodiment was described above, the present invention is not limited to the above-described embodiment, and various modifications are possible without departing from the gist of the invention. Hereinafter, modified examples will be described.

5-1

In the above-described embodiment, the current collector 100 included a dispersant for a conduction material. However, the current collector 100 does not necessarily need to include a dispersant for a conduction material. The current collector 100 need only include at least a polyolefin resin and a conductive carbon filler.

5-2

In the above-described embodiment, the current collector 100 was constituted by a single layer. However, the current collector 100 does not necessarily need to be constituted by a single layer. For example, current collector 100 may also be constituted by multiple layers each constituted by a polyolefin resin and a conductive carbon filler.

### 6. WORKING EXAMPLES, ETC.

Table 1, in which working examples and comparative examples are summarized, will be shown below.

TABLE 1

| | Work. | Work. | Work. | Work. | Work. | Work. | Work. | Work. | Work. | Work. |
|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 |
| Resin | PP | PP | PP | PP | PP | PP | PP | PP | PP | PP |
| Con- | CB | CB | CB | CB | CB | CB | CB | CB | CB | CB |
| ductive | | | | | | | | | | |
| carbon | | | | | | | | | | |
| filler | | | | | | | | | | |
| Thickness | 48 | 62 | 47 | 21 | 20 | 35 | 51 | 46 | 46 | 45 |
| [μm] | | | | | | | | | | |
| Rz in TD | 2.1 | 1.7 | 1.0 | 1.5 | 2.2 | 3.7 | 1.0 | 2.4 | 2.0 | 2.0 |
| [μm] | | | | | | | | | | |
| MD yield | 34.2 | 30.9 | 32.6 | 29.0 | 34.2 | 37.6 | 34.3 | 36.3 | 35.9 | 37.1 |
| point | | | | | | | | | | |
| strength | | | | | | | | | | |
| [MPa] | | | | | | | | | | |
| TD yield | 34.2 | 31.5 | 33.1 | 29.5 | 31.6 | 28.3 | 31.8 | 34.6 | 35.6 | 33.2 |
| point | | | | | | | | | | |
| strength | | | | | | | | | | |
| [MPa] | | | | | | | | | | |
| Strength | 1.00 | 1.02 | 1.02 | 1.02 | 0.92 | 0.75 | 0.93 | 0.95 | 0.99 | 0.90 |
| TD/MD | | | | | | | | | | |
| ratio | | | | | | | | | | |
| MD tear | 81.4 | 116.3 | 125.2 | 117.9 | 85.0 | 67.5 | 154.5 | 79.0 | 90.4 | 72.4 |
| strength | | | | | | | | | | |
| [kN/m] | | | | | | | | | | |
| | | | | Comp. | Comp. | Comp. | Comp. | Comp. | Comp. | Comp. |
| | | | | Ex. 1 | Ex. 2 | Ex. 3 | Ex. 4 | Ex. 5 | Ex. 6 | Ex. 7 |
| | | | Resin | PP | PP | PP | PP | PP | PP | PP |
| | | | Con- | CNT | CNT | CNT | CNT | CNT | CNT | CB |
| | | | ductive | | | | | | | |
| | | | carbon | | | | | | | |
| | | | filler | | | | | | | |
| | | | Thickness | 79 | 77 | 77 | 78 | 80 | 80 | 26 |
| | | | [μm] | | | | | | | |
| | | | Rz in TD | 4.2 | 4.0 | 4.0 | 3.4 | 4.3 | 4.6 | 6.2 |
| | | | [μm] | | | | | | | |
| | | | MD yield | 30.9 | 30.4 | 31.2 | 27.9 | 31.8 | 31.1 | 37.0 |
| | | | point | | | | | | | |
| | | | strength | | | | | | | |
| | | | [MPa] | | | | | | | |
| | | | TD yield | 19.4 | 19.5 | 24.0 | 17.0 | 23.1 | 25.2 | 35.2 |
| | | | point | | | | | | | |
| | | | strength | | | | | | | |
| | | | [MPa] | | | | | | | |
| | | | Strength | 0.63 | 0.64 | 0.77 | 0.61 | 0.73 | 0.81 | 0.95 |
| | | | TD/MD | | | | | | | |
| | | | ratio | | | | | | | |
| | | | MD tear | 26.4 | 34.1 | 36.5 | 32.1 | 35.9 | 33.1 | 55.4 |
| | | | strength | | | | | | | |
| | | | [kN/m] | | | | | | | |

In Table 1, “PP” indicates polypropylene. Also, “CB” indicates carbon black, and “CNT” indicates carbon nanotubes. Working Examples 1 to 10 and Comparative Examples 1 to 7 are each a current collector for a positive electrode of a lithium ion battery. As shown in Table 1, in each of Working Examples 1 to 10, polypropylene was used as the polyolefin resin, and carbon black was used as the conductive carbon filler. Also, in each of Comparative Examples 1 to 6, polypropylene was used as the polyolefin resin, and carbon nanotubes were used as the conductive carbon filler. Also, in Comparative Example 7, polypropylene was used as the polyolefin resin, and carbon black was used as the conductive carbon filler.

In each of Working Examples 1 to 10 and Comparative Examples 1 to 7, by setting the above-described manufacturing conditions as appropriate, the various parameters of the current collector (thickness, ten-point average roughness Rz in the TD, yield point strength in the MD, yield point strength in the TD, and tear strength in the MD) were adjusted.

As shown in Table 1, if the ten-point average roughness Rz in the TD is less than 4.0 μm and the value obtained by dividing the yield point strength in the TD by the yield point strength in the MD is at least 0.75 and at most 1.10 (Working Examples 1 to 10), the tear strength in the MD is at least 67.5 kN/m. That is, the tear strength in the MD of Working Examples 1 to 10 was higher than the tear strength in the MD of Comparative Examples 1 to 7.

### LIST OF REFERENCE NUMERALS

50 Test piece
100 Current collector
200 T die

1. A resin current collector for a positive electrode of a lithium ion battery, comprising:
a polyolefin resin; and
a conductive carbon filler,
wherein a value obtained by dividing a yield point strength in a TD (Traverse Direction) by a yield point strength in a MD (Machine Direction) is at least 0.75 and at most 1.10, and
a ten-point average roughness Rz in the TD is less than 4 μm.

2. The resin current collector according to claim 1, wherein a penetration resistance value is at most 30 Ω·cm².

3. The resin current collector according to claim 1, wherein a tear strength in the MD is at least 60 kN/m.

4. The resin current collector according to claim 1,
wherein the conductive carbon filler is carbon black,
a thickness is at least 20 μm and at most 100 μm,
the ten-point average roughness Rz in the TD is at least 0.5 μm and at most 3.7 μm,
the yield point strength in the TD is at least 25 MPa,
the yield point strength in the MD is at least 29 MPa,
a value obtained by dividing the yield point strength in the TD by the yield point strength in the MD is at least 0.90 and at most 1.05, and
the tear strength in the MD is at least 70 kN/m.

5. The resin current collector according to claim 1,
wherein the ten-point average roughness Rz in the TD is at least 0.7 μm and at most 2.5 μm, and
the yield point strength in the TD is at least 29 MPa.

6. The resin current collector according to claim 2, wherein a tear strength in the MD is at least 60 kN/m.

7. The resin current collector according to claim 2,
wherein the conductive carbon filler is carbon black,
a thickness is at least 20 μm and at most 100 μm,
the ten-point average roughness Rz in the TD is at least 0.5 μm and at most 3.7 μm,
the yield point strength in the TD is at least 25 MPa,
the yield point strength in the MD is at least 29 MPa,
a value obtained by dividing the yield point strength in the TD by the yield point strength in the MD is at least 0.90 and at most 1.05, and
the tear strength in the MD is at least 70 kN/m.

8. The resin current collector according to claim 3,
wherein the conductive carbon filler is carbon black,
a thickness is at least 20 μm and at most 100 μm,
the ten-point average roughness Rz in the TD is at least 0.5 μm and at most 3.7 μm,
the yield point strength in the TD is at least 25 MPa,
the yield point strength in the MD is at least 29 MPa,
a value obtained by dividing the yield point strength in the TD by the yield point strength in the MD is at least 0.90 and at most 1.05, and
the tear strength in the MD is at least 70 kN/m.

9. The resin current collector according to claim 2,
wherein the ten-point average roughness Rz in the TD is at least 0.7 μm and at most 2.5 μm, and
the yield point strength in the TD is at least 29 MPa.

10. The resin current collector according to claim 3,
wherein the ten-point average roughness Rz in the TD is at least 0.7 μm and at most 2.5 μm, and
the yield point strength in the TD is at least 29 MPa.

11. The resin current collector according to claim 4,
wherein the ten-point average roughness Rz in the TD is at least 0.7 μm and at most 2.5 μm, and
the yield point strength in the TD is at least 29 MPa.
